(19) United States
(12) Patent Application Publication
(10) Pub. No.: US 2002/0145108 A1
(43) Pub. Date: Oct. 10, 2002

(54) Rotary encoder

(76) Inventor: Anton Rodi, Leimen (DE)

Correspondence Address: LERNER AND GREENBERG, P.A., POST OFFICE BOX 2480, HOLLYWOOD, FL, 33022-2480, US

(21) Appl. No.: 10/116,534

(22) Filed: Apr. 4, 2002

(30) Foreign Application Priority Data
Apr. 5, 2001 (DE) 101 17 197.8

(51) Int. Cl. G01D 5/34

(52) U.S. Cl. 250/231.14

(57) ABSTRACT

A rotary encoder measures the rotation of a shaft and is configured such that the rotary encoder has no bearing arrangement of its own.

### BACKGROUND OF THE INVENTION

1. Field of the Invention

The present invention relates to a rotary encoder.

The term rotary encoder is to be understood as describing an angular position/position measuring system, which measures the angle of rotation or the corresponding displacement of a shaft. The shaft can, for example, be the shaft of a motor.

So-called resolvers are used for absolute angular position/position measuring systems. These resolvers in single-pole or multi-pole design provide SIN/COS signals corresponding to the angle (position) for signal processing. Up to now, this robust and temperature-insensitive encoder variant has, for example, been used in large numbers for a plurality of electric motors (approximately 90% of variable-speed drives). The proven cost effective resolvers are, however, no longer sufficient as regards resolution and accuracy above, for example, 12 or 13 bits for the increasingly demanding servo control systems. The resolvers also do not allow multiple recordings of revolutions (so-called multi-turn functions), meaning that enclosed high-resolution rotary encoders that have their own enclosed bearing arrangement are being increasingly used.

These encoders are, however, bulky, and expensive due to their 5 having their own bearing arrangement and generate considerable over-temperatures due both to their bearing arrangement and seals. Particularly with electric motors which are installed in areas with high ambient temperatures of over 100° C., the additional heat generated by these enclosed encoders with their own bearing arrangement causes distinct problems in function and reliability for the optical and electronic systems.

### SUMMARY OF THE INVENTION

It is accordingly an object of the invention to provide a rotary encoder which overcomes the above-mentioned disadvantages of the heretofore-known encoders of this general type and which is inexpensive.

With the foregoing and other objects in view there is provided, in accordance with the invention, a rotary encoder having a pivoted scale (4a) and a scanning system (7, 8, 9) for a device with a housing (1) and a rotating shaft (3) supported to this housing (1), wherein the encoder, which is mounted without a shaft and an associated bearing arrangement of its own, comprises a sleeve-like housing (5) with at least two precisely machined functional surfaces (12); the scanning system (7, 8, 9) of the encoder is mounted and aligned in relation to these functional surfaces (12); the housing (1) of the device is provided with corresponding functional surfaces (12) for receiving the sleeve-like housing 5, and the scale (4a) is connected to the shaft (3) of the device.

According to another feature of the invention, the pivoted part (4, 4a) of the rotary encoder also has functional surfaces for its accurate axial alignment.

According to another feature of the invention, the inside of the sleeve-like housing (5) is sealed off with a cover (10).

According to another feature of the invention, dust seals (14, 15) are provided to seal off the housing (5) from the inside of the device.

According to another feature of the invention, at least parts of the housing and the cover disks screen the respective encoder system (optically, magnetically etc.) as far as possible from external interfering radiation.

In the rotary encoder according to the invention which has no bearing arrangement of its own the disadvantages with regard to volume, temperature and price of enclosed encoders with their own bearing arrangements are avoided as far as possible, while time-consuming installation operations and the dirt-sensitive nature of prior art incremental built-in encoders have been eliminated.

The basic idea behind the invention lies, on the one hand, in the functional linking of the housing that encases the rotary encoder with the precisely fitted or installed scanning system and, on the other hand, in the form-fit connection of the housing to the housing of a device, for example a motor, that has been prepared and adjusted in a correspondingly precise manner.

The scale disk must also be fitted to the shaft as precisely as possible without adjustment aids. The scale disk, in accordance with the invention, is also to have a fixed connection to a member, whose functional surface is meticulously related to the scale axis and is to serve for the accurately fitting working connection to the shaft. A simple solution could, for example, be a correspondingly formed steel sleeve, which has an extremely precise internal diameter and onto which the scale disk with the scale track is aligned centrally and glued down. The sleeve with the scale disk (which may, for example, be made of glass, plastic or metal) can then simply be affixed to the precisely fitting shaft without the need for time-consuming adjustment measures.

In this way, easily-mountable built-in encoders with high resolution can be precisely fitted, for example in existing electric motors, and operation in predominantly dust and oil-free environments can be ensured. Aside from the space-saving advantages that this installation offers, heating by encoder bearings is also eliminated. The design of the rotary encoder in accordance with the invention also permits the use of high-precision encoder systems in hostile environments, for example electric motors, and with a corresponding manufacturing number these encoders eliminate the price advantage enjoyed by resolvers.

Other features which are considered as characteristic for the invention are set forth in the appended claims.

Although the invention is illustrated and described herein as embodied in a rotary encoder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, partial sectional view of a first exemplary embodiment of a rotary encoder according to the invention; and

FIG. 2 is a diagrammatic, partial sectional view of a second exemplary embodiment of a rotary encoder according to the invention.

### DESCRIPTION OF THE PREFERRED EMBODIMENTS:

Referring now to the figures of the drawings, two exemplary embodiments of the present invention are described below in detail.

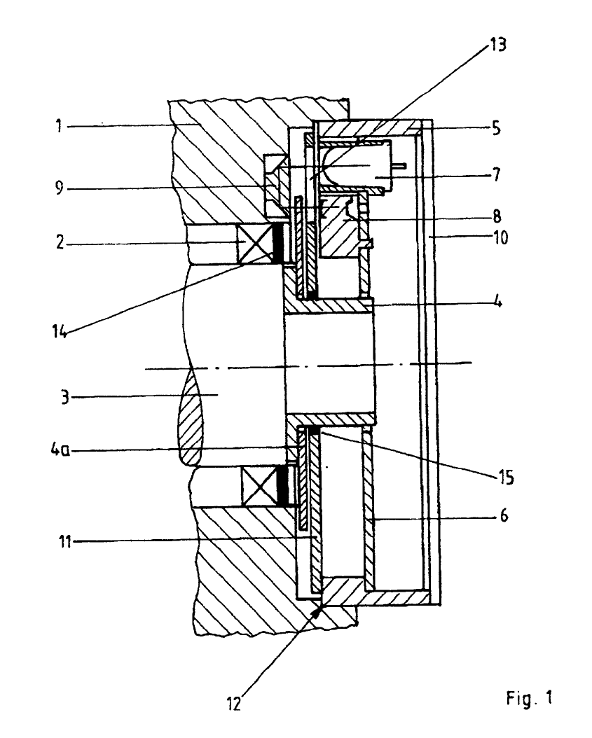

FIG. 1 shows a housing 1, on which a shaft 3 is pivotally mounted by means of a bearing 2. A sleeve 4 is slid over and fixed to shaft 3. A scale disk 4a of an optical scanning system is precisely mounted on this sleeve 4.

The rotary encoder has a sleeve-shaped housing 5. A mother board 6 is attached inside this housing 5. This mother board 6 carries an illuminating device 7 and, for example, an optoelectronic evaluation arrangement 8. The scanning system further comprises a prism 9 that is attached to the housing 1. The rotary encoder has a cover 10 on its outside. A sealing disk 11 with optical window 13 is provided on the inside.

Two functional surfaces 12 at right angles are formed on the housing 1, one of which is the front surface, the other being the outer surface. When fitted, as illustrated by the figure, the corresponding surfaces of housing 5 are in contact with these surfaces.

Dust seals 14,15 can be provided at the bearings 2 and/or between sealing disk 11 and shaft 3 or sleeve 4 to further seal the interior.

In the scanning system shown, the illumination device 7 emits a light beam through the optical window 13 to the prism 9, where the light beam is deflected by 180° and returned through the scale disk 4a to the optoelectronic evaluation device 8.

FIG. 1 shows a shaft with housing and a built in encoder. This means that the housing is provided with surfaces for receiving the correspondingly fitting functional surfaces of the rotary encoder. With a precise external diameter of the housing 5, the encoder is inserted appropriately for function into the housing 1, providing a sliding fit or press-fit, and additionally fastened there, for example by gluing. In accordance with the external diameter of the housing 5, the optical system was firmly aligned in an absolutely central position observing an appropriate distance to the front surface of the housing 5 in a preceding step on an assembly station. Correspondingly, the prism 9 for optical deflection of the light beam was firmly attached to the housing in a preceding step, and the sleeve 4 attached to the shaft 3, for example by being pressed on, which holds the scale disk, for example a glued-on glass scale disk 4a, which was accurately fixed in position in a preceding step.

This provides for an easy, accurate and functional method of fixing the rotary encoder without needing any adjusting aids, and is suitable for qualitatively high-resolution measurements of relative movements between shaft 3 and housing 1. By using the sealing disk 11 with an optical window 13, for example made of glass for optical encoders, the rotary encoder is protected from dust as far as possible and therefore suitable for use in installation locations subject to extreme soiling.

The internal surfaces (internal diameter) of housing 5 and a corresponding outer surface of housing 1 could also be used as functional surfaces. Instead of the front surface that determines the distance of the encoder, other equivalent measures can be implemented on the outer contours which meet the functional requirements of the encoder system in conjunction with the housing installation space.

The basic principles can be applied to all the built-in encoders, regardless of whether the active encoder system is based on optical, magnetic, inductive, electromagnetic, electro-mechanic, electrostatic or other principles of operation.

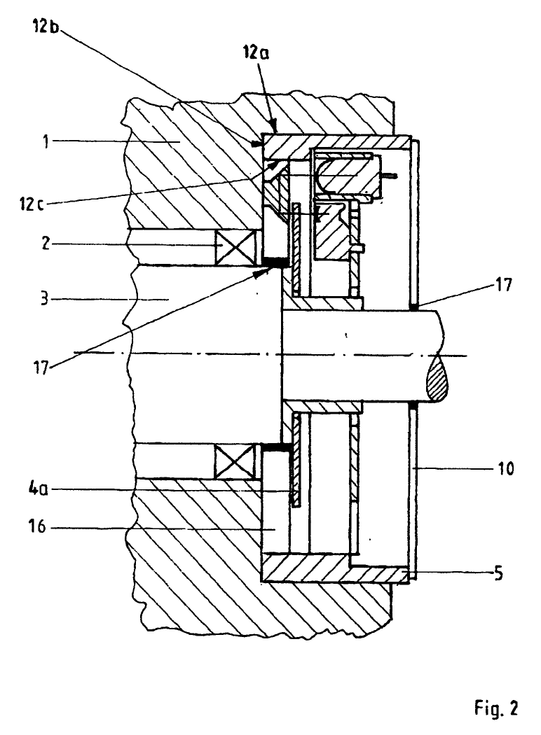

FIG. 2 differs from FIG. 1 in that the shaft 3 is passed through the cover 10, where a dust seal 17 is provided.

FIG. 2 shows an even more refined method of sealing the encoder itself. This is achieved by corresponding measures implemented prior to the installation of the encoder that become effective during assembly. A cover disk 16 is shown that is inserted accordingly into the installation space prior to fitting of the scale disk 4a. When fitting the encoder, for example by means of the press-fit on the outer diameter 12a, the cover disk 16 of optical measuring systems is also firmly fixed, for example by means of the press-fit, to the inner diameter 12c of the housing 5 on the last section of the fitting-path 12b.

For reasons of practicality, the cover disk 16 also comprises the deviating prism 9 to ensure an accurately-positioned installation, and also has corresponding dust seals 17, as is the case with cover 10 of the encoders.

This means that the encoder has created its own installation 5 space, which offers as far as possible the necessary protection of the respective encoder principle applied (optical, magnetic etc.) and also of the scale disk from soiling, and from negative ambient influences.

For reasons of practicality, the housing 5, cover disks 11,16 and cover 10 are made of materials that protect the encoder as far as possible from external sources of interference, such as electromagnetic interference, optical beams and magnetic fields. This offers the advantage that, aside from dust protection, the encoder system with scale disk and respective evaluation system is kept reproducible and free from interference in performing its measuring task.

I claim:

1. A rotary encoder having a pivoted scale (4a) and a scanning system (7, 8, 9) for a device with a housing (1) and a rotating shaft (3) supported to this housing (1), wherein the encoder, which is mounted without a shaft and an associated bearing arrangement of its own, comprises a sleeve-like housing (5) with at least two precisely machined functional surfaces (12); the scanning system (7, 8, 9) of the encoder is mounted and aligned in relation to these functional surfaces (12); the housing (1) of the device is provided with corresponding functional surfaces (12) for receiving the sleeve-like housing 5, and the scale (4a) is connected to the shaft (3) of the device.

2. The rotary encoder according to claim 1, wherein the pivoted part (4, 4a) of the rotary encoder also has functional surfaces for its accurate axial alignment.

3. The rotary encoder according to claim 1, wherein the inside of the sleeve-like housing (5) is sealed off with a cover (10).

4. The rotary encoder according to claim 1, wherein dust seals (14, 15) are provided to seal off the housing (5) from the inside of the device.

5. The rotary encoder according to claim 1, wherein at least parts of the housing and the cover disks screen the respective encoder system (optically, magnetically etc.) as far as possible from external interfering radiation.
